(19) United States
(12) Patent Application Publication
(10) Pub. No.: US 2005/0023048 A1
(43) Pub. Date: Feb. 3, 2005

(54) Load cell

(75) Inventor: Klaus Peter Selig, Balingen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Bizerba GmbH & Co. KG, Balingen (DE)

(21) Appl. No.: 10/895,716

(22) Filed: Jul. 21, 2004

Related U.S. Application Data
(63) Continuation of application No. PCT/EP03/00313, filed on Jan. 15, 2003.

(30) Foreign Application Priority Data
Jan. 26, 2002 (DE) 10202951.2

(51) Int. Cl. G01G 3/08

(52) U.S. Cl. 177/229

(57) ABSTRACT

In order to provide a load cell with a force transducer for recording a weight force to be determined, the force transducer having a part which does not deform and is fixed to the housing, an elastically deformable spring part and a force introducing part, with a sensor arrangement for sensing the deformation of the spring part and also with a device to compensate for an initial load, of a simple construction and for acceptable production costs, it is proposed that the compensation device comprises a spring which is directly connected to the force introducing part, on which the weight force to be determined acts, and which exerts, on the force introducing part, a corrective force that is opposed to the weight force.

This application is a continuation of PCT Application No. PCT/EP03/00313 and claims priority to German application No. 102 02 951.2 of Jan. 26, 2002, both of which are incorporated herein by reference in their entirety and for all purposes.

### BACKGROUND OF THE INVENTION

The invention relates to a load cell with a force transducer for recording a weight force to be determined, the force transducer having a part which does not deform and is fixed to the housing, an elastically deformable spring part and a force introducing part, with a sensor arrangement for sensing the deformation of the spring part and also with a device to compensate for an initial load.

In weighing units, electromechanical force transducers, also known as load cells, are usually used today for the conversion of the weight force to be determined into an electrical value. This electrical value is then further processed in a suitable form, in order to present the measured value in units of weight in a form which the user can read on a display of the weighing unit. The load cells that are most frequently used are based on the strain gage technique or on the principle of electromagnetic force compensation.

During the operation of a weighing unit, the load cells are not only loaded with the weight of the item being weighed but also with a constant initial load, which is made up of the weight of the so-called loading plate of the weighing unit, on which the item to be weighed can be placed, and also of the force introducing parts of the weighing unit itself. A further component of the initial load is, for example, the weight force of an accommodating container for a specific item to be weighed.

In the case of many weighing units, the initial load amounts to about 10 to 20% of the working load range of the weighing unit, i.e. the load cell must have a load carrying capacity that is approximately 10 to 20% higher than the working load range of the weighing unit. For a weighing unit with a working load range of 15 kg, therefore, normally a load cell with a load carrying capacity of 18 kg is used.

Making the load carrying capacity of the load cell greater in this way does not in itself present any problem for weighing units of this generic type.

However, there are also weighing units for special applications for which the initial load is very much greater. In many cases, these are weighing units with passive or actively driven roller conveyors or transporting belts which are mounted on the loading plate and on which the item to be weighed is transported over the weighing unit and weighed as it passes through. Also to be mentioned here are container weighing units with large initial loads caused by the weights of the containers.

In the case of such weighing units, the initial load is almost as much as the weighing range itself, and there are even cases in which the initial load is much greater than the weighing range of the weighing unit.

For example, there are known areas of use for weighing units in which the weighing range is 1 kg and the initial load is 3 kg. There are considerable technical problems in producing such weighing units.

In the example mentioned above, with a weighing unit having a weighing range of 1 kg and an initial load of 3 kg, the load cell used must have a load carrying capacity of at least 4 kg. Since only 1 kg is used in the measurement, this means that only 25% of the available measuring range of the load cell is utilized. If in this example an error-free graduation of the weighing unit of 0.1 is assumed, which is a value often required, the weighing unit has an accuracy of 1000 g/0.1 g, corresponding to 10 000 graduations.

For the load cell itself, this takes on an entirely different perspective.

Since the load cell has a load range of 4 kg, a resolution of 0.1 g according to the above example requires 4000 g/0.1 g, i.e. 40 000 graduations, for the load cell. Accordingly, the load cell must have an accuracy which is four times the accuracy of the weighing unit. This is a considerable requirement for the weighing system and requires correspondingly high expenditure in terms of structural design and in financial terms.

Added to this is the fact that the output signal of the load cell (usually an electric voltage) which is used for the actual weight determination is only 25% of the maximum possible value. On account of this much smaller output signal, the immunity of such a system to electromagnetic interference decreases, which either reduces the measuring accuracy or necessitates additional shielding measures.

It is known from JP 09-243 441 A1 to realize initial load compensation by means of a second, actively operated load cell using magnetic force compensation. This solution is technically very complex and, on account of the use of two load cells, is very expensive.

DE 200 22 494 U1 takes a different approach, which provides a transmission lever which is formed on the end of the force introducing part that is fixed to the housing and by means of which a force which serves for initial load compensation can be introduced on the principle of a beam balance. This solution also requires a complex construction of the load cell and consequently leads to high production costs.

In a special case, a spring is used here to compensate for the initial load. However, this does not act directly on the force introducing part, but is connected to the latter via a lever mechanism. This leads to an oscillating behavior of the load cell, which makes it unsuitable for many intended uses. This applies in particular to use in the case of independently operating weighing devices, as are frequently used in the case of material conveying lines.

An object of the present invention is to develop a load cell in such a way that the aforementioned disadvantages are avoided in operation with high initial loads.

### SUMMARY OF THE INVENTION

This object is achieved according to the invention in the case of the load cell described at the beginning by the compensation device comprising a spring which is directly connected to the force introducing part, on which the weight force to be determined acts, and which exerts, on the force introducing part, a corrective force that is opposed to the weight force.

The solution according to the invention for achieving the object appears at first glance to be afflicted by considerable problems, in view of the idea of making a force that opposes the weight force to be measured act directly on the force introducing part in the form of the spring, the “errors” of which directly affect the accuracy of the weighing unit and the reliability of the weighing result. Since the spring acts directly on the force introducing part, any changes in the spring force lead directly to a measuring error of the load cell. The causes of changes in the spring force of the spring that are relevant in this connection are as follows:
dependence of the spring force on temperature (temperature coefficient of the modulus of elasticity of the spring)
material creep in the spring material
changes at the fixing/restraining points of the spring
changes at the end support of the spring.

However, it is surprisingly found that it is quite possible for the aforementioned problems to be overcome, as shown below:

Temperature-induced changes in the spring force can be counteracted by using for the spring material a special metal alloy, with a temperature coefficient that is much lower than in the case of customary spring steel. Materials which in this respect exhibit a coefficient that is 100 times smaller are best suited for this purpose. This applies in particular to nickel-iron-chromium alloys, as can be obtained for example under the trade name “Thermelast” from the company Vakuumschmelze GmbH & Co. KG, Hanau. The use of such materials consequently reduces the measuring errors induced by temperature changes by a factor of 100.

The other causes of measuring errors mentioned above prove to be insignificant in comparison with the measuring error induced by temperature changes.

Any fixed part of the housing construction may be used in principle as an end support for the spring, for example the frame of the weighing unit or the base plate of the weighing unit, to which the non-deforming part that is fixed to the housing is secured.

However, it is found that the frame of the weighing unit or the base plate of the weighing unit are generally not stiff enough and deformations of these parts during the loading of the weighing unit cause measuring errors via the end support of the spring.

Therefore, the load cell according to the invention is preferably constructed in such a way that it can be fitted and exchanged as a unit. For this purpose, it is preferably provided that the force transducer comprises the end support, and that the spring of the compensation device is connected on the one hand to the force introducing part and on the other hand to the end support of the force transducer.

This avoids relative movements of the end support and the load cell, which are otherwise evident directly as changes in the force on the spring, and consequently as weighing errors.

The end support is preferably formed as an extension arm, which extends from the part of the force transducer that is fixed to the housing substantially parallel to the force introducing part.

The end support and the extension arm may be separate parts which are secured, for example screwed, to the part of the force transducer that is fixed to the housing, or else preferably formed in one piece with the further components of the force transducer, i.e. in particular produced from one block together with the part that is fixed to the housing and the force introducing part.

The spring used to compensate for the initial load in the case of the load cell according to the invention is preferably formed as a tension spring.

As stated above, the selection of the spring materials is of particular importance if providing the weighing unit with great accuracy or a great immunity to interference is a concern. In this respect, it is to be recommended to produce the spring from a material of which the temperature coefficient of the modulus of elasticity is <5 ppm/° C.

Particularly preferred materials are nickel-iron-chromium alloys, which can in particular also satisfy aforementioned requirements with respect to the temperature coefficient of the modulus of elasticity.

An actual example of this is the so-called Thermelast material from the company Vakuumschmelze GmbH & Co. KG, Hanau.

A further significant improvement of such a system is achieved by suitable setting of the spring stiffness of the spring. This is so because it is found that the spring stiffness can be set independently of the spring force to be applied by means of suitable geometrical design of the spring. The mechanism of the advantage which can be achieved as a result is described below.

All load cells undergo a deformation or deflection of the load cell body under the loading of the weight force to be measured. This means that, under loading, the force introducing part of the load cell is displaced in the direction of the force that is acting.

Consequently, under loading with the weight force to be measured, a load cell itself behaves like a spring. Since this deformation or deflection is very small (generally in the range of some tenths of a millimeter), this means that the “load cell spring” has a very high stiffness. In quantitative terms, this is expressed by the so-called spring stiffness k_{WZ}. This spring stiffness is defined as the quotient of the force acting and the displacement of the spring. For known load cells with a measuring range of approximately 10 kg (corresponding to 100 N), spring constants k_{WZ} of approximately 300 N/mm are found.

In the case of the initial load compensation according to the invention with the aid of a spring, this spring is disposed in terms of force parallel to the “load cell spring”. An exact analysis shows that the measuring errors that are produced by the compensation spring itself are only registered in the ratio of the spring stiffnesses k_{KF}/k_{WZ}, where k_{KF} is the spring constant of the compensation spring and k_{WZ} is the spring constant of the load cell.

Consequently, if it is ensured by the structural design of the compensation spring that it has a much smaller spring constant than the load cell, the influence of the error of the compensation spring is reduced considerably.

The load cell according to the invention is therefore preferably designed in such a way that the spring constant k_{KF} of the compensation spring is smaller by at least a factor of 10 than the spring constant k_{WZ} of the spring part of the load cell.

This factor may be increased in the structural design to 100 or more, a person skilled in the art being familiar with the measures that are to be taken.

The load cell according to the invention advantageously has a sensor arrangement with a strain gage, with which the elastic deformation of the spring part is determined.

As an alternative to this, it may be provided that the load cell has as a sensor arrangement/force measuring device an electromagnetic force compensating device.

These and further advantages of the invention are explained in more detail below with reference to the drawing.

### BRIEF DESCRIPTION OF THE DRAWINGS

FIG. 1 is a schematic representation of a load cell 10 according to teachings of the invention.

### DETAILED DESCRIPTION OF THE INVENTION

The load cell 10 according to the invention is in this case held on a housing (not shown) of a weighing unit by a part 11 that is fixed to the housing. Extending away from the part 11 that is fixed to the housing is a force introducing part 12, as a spring part, and substantially parallel to this, an extension arm 14. Between its free part and its part that is connected to the part 11 of the force transducer that is fixed to the housing, the force introducing part 12 has pivot points 16, which allow an elastic deformation of the force introducing part 12 when a force F acts on the free end of the force introducing part 12. Disposed on the upper side of the force introducing part 12 in the region of the pivot points 16 are two strain gages 18, by means of which the extent of the deformation of the force introducing part 12 can be measured and consequently the force F can be determined.

To compensate for the initial load which acts on the force introducing part 12, a spring 20 is provided, which spring is formed as a tension spring and is secured by one end to an end support 22 on the force introducing part 12 and is held by its other end on the extension arm 14, i.e. is consequently fixed to the housing.

On account of the spring force of the tension spring 20, the initial load acting on the force introducing part can be compensated, so that the force introducing part 12 only has to be designed for the weighing range that is actually desired.

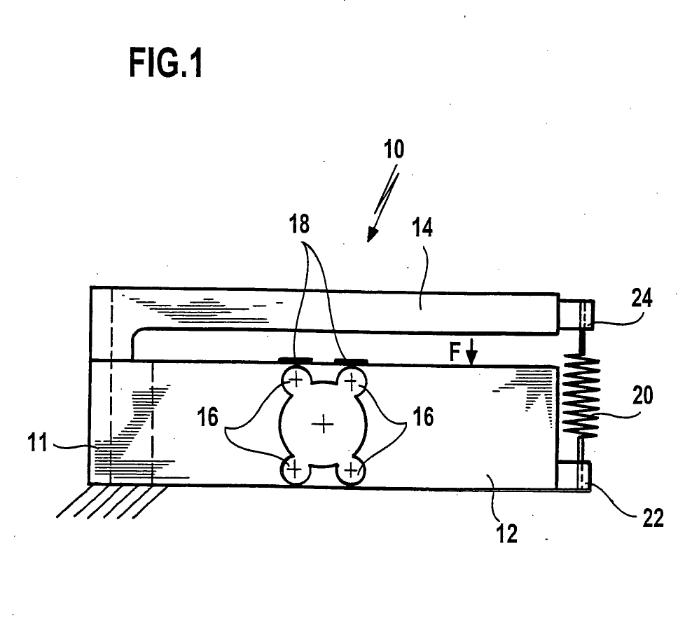

The extension arm 14 and the part 11 that is fixed to the housing, together with the force introducing part 12, may if appropriate be formed in one piece and not, as shown in the example of FIG. 1, made up of two parts.

In the case of the embodiment shown in FIG. 1, in which the tension spring 20 which is used to compensate for the initial load is secured by both ends to parts of the load cell, it is advantageous that this type of initial load compensation always produces a constant initial load correction independently of the housing and its possible bending deflections or distortions. Consequently, measuring errors of such a kind are avoided from the outset.

As shown, the compensation spring 20 is secured at its ends at the clamping securing features 22 and 24, but the spring could also be secured to the force introducing part 12 or to the extension arm 14 by means of a weld spot, for example by means of laser welding, instead of the clamping connections 22, 24. This allows changes at the securing or restraining points of the spring 20 during the service life of the load cell to be largely eliminated, which serves to minimize causes of measuring errors further.

The use of suitable alloys, such as for example the nickel-iron-chromium alloy “Thermelast”, for the production of the compensation spring 20 allows measuring errors induced by temperature changes to be largely eliminated.

1. A load cell comprising a housing, and a force transducer for recording a weight force to be determined, the force transducer having a part which does not deform, the part being fixed to the housing, the force transducer further comprising an elastically deformable spring part and a force introducing part, the force introducing part comprising a sensor arrangement for sensing the deformation of the spring part, the load cell further comprising a compensation device to compensate for an initial load acting on the spring part, the compensation device comprising a spring which is directly connected to the force introducing part, the weight force to be determined acting upon the force introducing part, the compensation device exerting a corrective force that is opposed to the weight force on the force introducing part, the force transducer comprising an end support, the spring of the compensation device being connected to the force introducing part and to the end support of the force transducer, the spring being produced from a material having a temperature coefficient of the modulus of elasticity of less than 5 ppm/° C.

2. The load cell according to claim 1, wherein the end support comprises an extension arm, said extension arm extending from the part of the force transducer that is fixed to the housing substantially parallel to the force introducing part.

3. The load cell according to claim 1, wherein the end support is formed in one piece with at least a portion of the force transducer.

4. The load cell according to claim 1, wherein the spring is a tension spring.

5. The load cell according to claim 4, wherein the spring comprises a nickel-iron-chromium alloy.

6. The load cell according to claim 1, wherein the spring constant k_{KF} of the spring is less by at least a factor of 10 than the spring constant k_{WZ} of the spring part.

7. The load cell according to claim 1, wherein the spring is connected to the force introducing part by means of laser spot welding.

8. The load cell according to claim 1, wherein the elastic deformation of the spring part is determined by means of a sensor arrangement with a strain gage.

9. The load cell according to claim 1, wherein the load cell comprises an electromagnetic force compensating device as a sensor arrangement.
